(19) United States
(12) Patent Application Publication
(10) Pub. No.: US 2010/0053662 A1
(43) Pub. Date: Mar. 4, 2010

(54) DOCUMENT TRANSMISSION SYSTEM AND METHOD

(76) Inventor: Chen-Ning Hsi, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/198,862

(22) Filed: Aug. 26, 2008

(51) Int. Cl. G06F 3/12

(52) U.S. Cl. 358/1.15

(57) ABSTRACT

A document transmission system includes a document provider, a document receiver, and a network transmission system. The document provider is utilized for providing a document. The document receiver is utilized to receive a paper with data to provide a document. The network transmission system is utilized for respectively providing network addresses to the document provider and the document receiver, and for transmitting the document from the document provider to the document receiver according to the network addresses.

### BACKGROUND OF THE INVENTION

1. Field of the Invention

The present invention relates to a document transmission system and method, and particularly relates to a document transmission system and method utilizing a network transmission system and a symbol to transmit a document.

2. Description of the Prior Art

A conventional facsimile (fax) machine is connected to a telephone network, and transmits a document to a target receiver such as a printer or another facsimile machine via the telephone network. In this case, a telephone number of the target receiver must be dialed before faxing the document, and therefore, a user must prepare the telephone number and further make sure that the telephone number is correct before faxing the document. The necessity of these steps causes some inconvenience to a user. Furthermore, a facsimile machine needs a telephone network, which is also inconvenient.

### SUMMARY OF THE INVENTION

Therefore, one objective of the present invention is to provide a document transmission that does not require a telephone system.

One embodiment of the present invention provides a document transmission system, which comprises a document provider, a document receiver, and a network transmission system. The document provider is utilized for providing a document. The document receiver is utilized to receive a paper with data to provide a document. The network transmission system is utilized for respectively providing network addresses to the document provider and the document receiver, and for transmitting the document from the document provider to the document receiver according to the network addresses.

Another embodiment of the present invention provides a document transmission method, which comprises: utilizing a document provider to receive a paper with data to provide a document; utilizing a document receiver to receive the document; and utilizing a network transmission system for respectively providing network addresses to the document provider and the document receiver, and for transmitting the document from the document provider to the document receiver according to the network addresses.

According to the above mentioned embodiment, a document transmission system utilizing no telephone systems is provided, and thus the application of the document transmission system increases.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a document transmission system according to a preferred embodiment of the present invention.

FIG. 2 is a schematic diagram illustrating a detailed description of a document transmission system according to a preferred embodiment of the present invention.

FIG. 3 is a schematic diagram illustrating how to use a symbol included in a document in order to transmit the document.

FIG. 4 is a flow chart illustrating a document transmission method according to a first embodiment of the present invention.

FIG. 5 is a flow chart illustrating a document transmission method according to a second embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

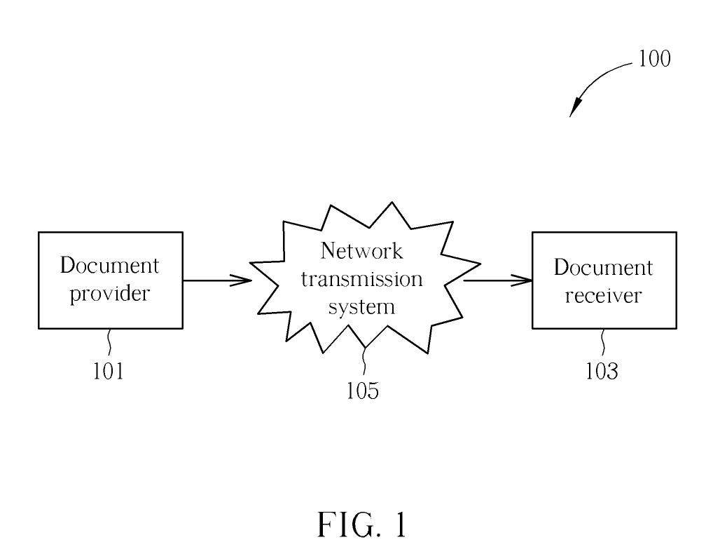

FIG. 1 is a block diagram illustrating a document transmission system 100 according to a preferred embodiment of the present invention. As shown in FIG. 1, the document transmission system 100 includes a document provider 101, a document receiver 103 and a network transmission system 117. The document provider 101 is utilized for providing a document. The document receiver 103 is utilized for receiving the document. The network transmission system 105 (for example, an IP transmission system) is utilized for respectively providing network addresses (e.g. an IP address) to the document provider 101 and the document receiver 103, and for transmitting the document from the document provider 101 to the document receiver 103 according to the network addresses. Compared with the prior art, the present invention provides a document transmission system that utilizes a network transmission system instead of a telephone system.

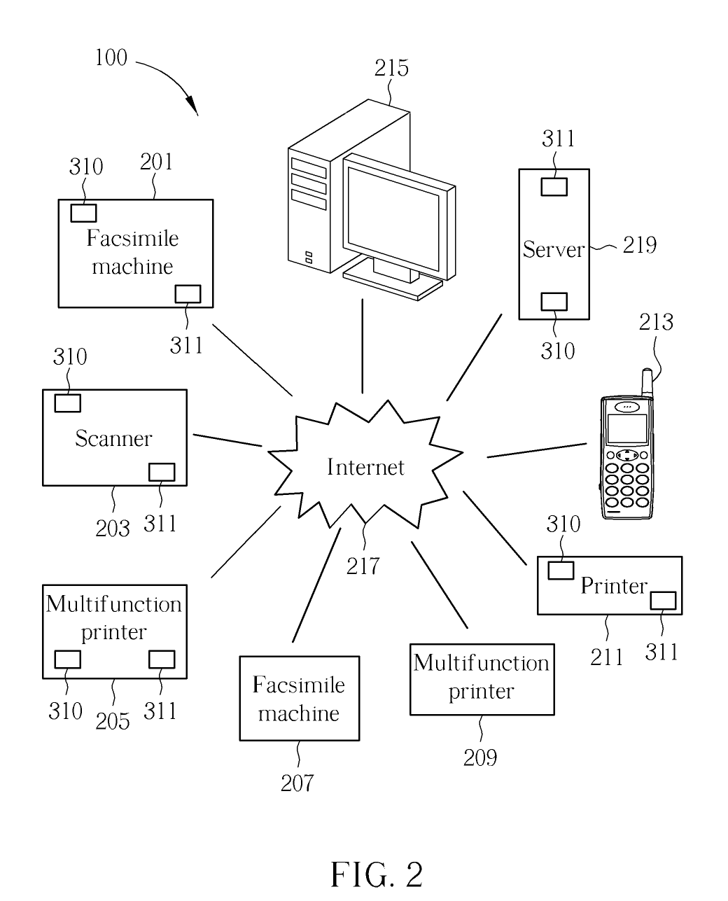

FIG. 2 is a schematic diagram illustrating a detailed description of a document transmission system according to a preferred embodiment of the present invention. Please jointly refer to FIG. 1 and FIG. 2 to understand the concept of the present invention more clearly. As shown in FIG. 2, the document provider 101 shown in FIG. 1 can be a facsimile machine 201, a scanner 203 or a multifunction printer 205; the document receiver 103 shown in FIG. 1 can be a facsimile machine 207, a multifunction printer 209, a printer 211, a mobile phone 213 or a computer 215; and the network transmission system 105 can be Internet 217 (or Intranet). The document provider 101 can receive data printed on a paper to provide the document, and the document receiver 103 can automatically print out the document when the document receiver 103 receives the document, if the document receiver 103 is the facsimile machine 207, the multifunction printer 209, the printer 211 or a similar apparatus.

As shown in FIG. 2, the document transmission system 100 can further include a server 219, for buffering the document when the document provider 101 sends the document but the document receiver 103 is unable to immediately receive the document.

If the document transmission system 100 utilizes a “point to point” mechanism to transmit the document from the document provider 101 to the document receiver 103, the document provider 101 and the document receiver 103 must have document transmission protocol programs (e.g. fax protocol programs) themselves. Also, if the document transmission system 100 utilizes a “routing” mechanism to transmit the document from the document provider 101 to the document receiver 103, the document transmission protocol program can be included in the network transmission protocol program provided for the network transmission system 105.

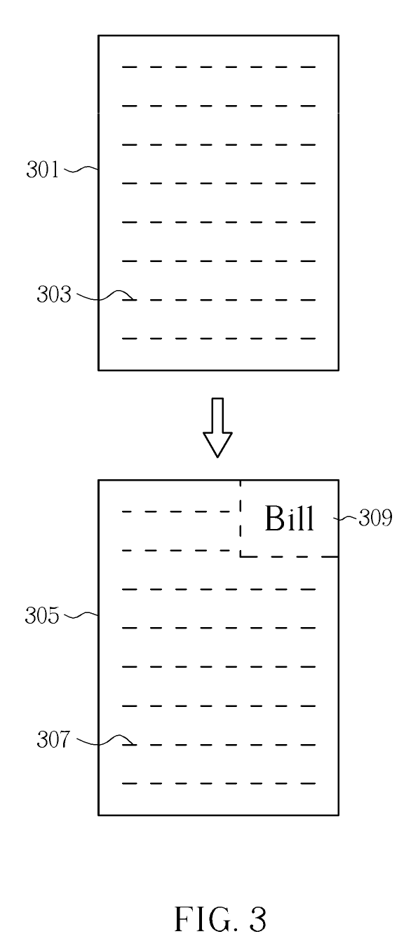

As well as the above-mentioned system, the present invention further provides an easy document transmission method to transmit a document through the above-mentioned systems via only a symbol included in the document instead of dialing telephone numbers. FIG. 3 is a schematic diagram illustrating how to use a symbol included in a document to transmit the document. As shown in FIG. 3, a conventional document 301 includes only a document concept 303, and a telephone number must be obtained and dialed when the conventional document 301 is to be transmitted via a facsimile machine. A document 305 provided by one embodiment of the present invention, however, includes not only document 307 but also a symbol region 309 having a symbol. An address of the document receiver 103 can be pre-stored in a storage device 310 and read according to the symbol in the symbol region 309, which can be identified by an identifying device 311. In one embodiment, at least one document receiver address is included in an address book, which can reside at least one of the document provider 101, the identifying device 310, and the server 219, and the symbol can be identified and then mapped to an address included in the address book via the identifying device 310. Then the document is transmitted according to the mapped address.

As in the example shown in FIG. 3, if the document 305 is to be faxed to a recipient named Bill, then a word “Bill” can be written on the symbol region 309. Also, the identifying device 310 identifies, recognizes the symbol and maps the symbol to the address of Bill's facsimile machine. By this way, the address of Bill's facsimile machine is obtained and the document can be transmitted accordingly. Such a document can be obtained via directly writing on a paper document and then scanned. Alternatively, the paper document can be scanned first and the symbol can be written on the symbol region 309 via a writing board or similar apparatus. The symbol for obtaining address can be any figure, number or word.

The identifying device 310 can be an optical characteristic reorganization (OCR) device, such as a web camera. In this case, the identifying device 310 can further include other devices besides the optical characteristic reorganization device for the mapping function. Further more, the identifying device 310 can further include a program and perform the mapping function via the control circuit of the optical characteristic reorganization device or other devices. Please refer to FIG. 2 again. One of the storage device 310 and the identifying device 311 can be provided in the facsimile machine 201, the scanner 203 or the multifunction printer 205. Alternatively, one of the storage device 310 and the identifying device 311 can be provided in the server 219.

It should be noted that, although the document transmission method shown in FIG. 3 utilizes the document transmission system shown in FIG. 2 in one example, the method shown in FIG. 3 is not limited to a network transmission system. It can also be utilized in a telephone system. In this case the address of the document receiver is preferably stored in the document provider.

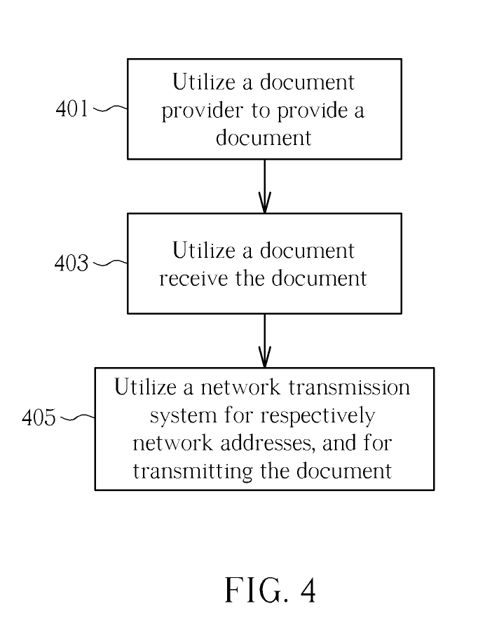

FIG. 4 is a flow chart illustrating a document transmission method according to a first embodiment of the present invention, which corresponds to the embodiment shown in FIG. 2. The document transmission method includes the following steps:

Step 401: Utilize a document provider to provide a document.

Step 403: Utilize a document receiver to receive the document.

Step 405: Utilize a network transmission system for respectively providing network addresses to the document provider and the document receiver, and for transmitting the document from the document provider to the document receiver according to the network addresses.

Other detailed characteristics are already illustrated in the above-mentioned embodiments, and are therefore omitted here for brevity.

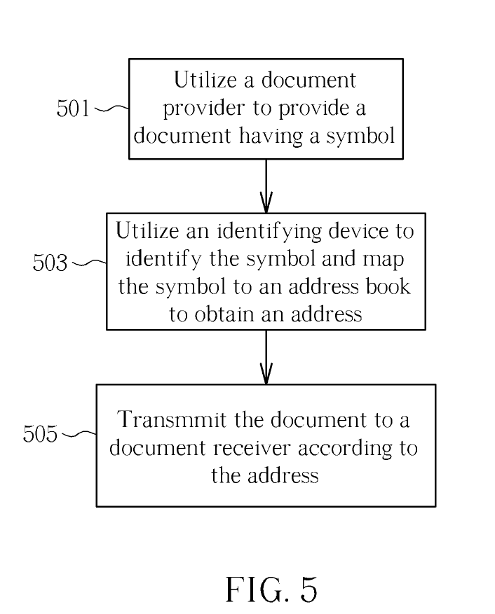

FIG. 5 is a flow chart illustrating a document transmission method according to a second embodiment of the present invention, which corresponds to the embodiment shown in FIG. 3. The document transmission method includes the following steps:

Step 501: Utilize a document provider to provide a document having a symbol.

Step 503: Utilize an identifying device to identify the symbol to obtain an address.

Step 505: Transmit the document to a document receiver according to the address.

Other detailed characteristics are already illustrated in the above-mentioned embodiments, and therefore are omitted here for brevity.

According to the above mentioned embodiments, a user can easily fax the document via a simple symbol instead of dialing a telephone number, significantly increasing the convenience of faxing documents. Also, the utilization of the network address system increases the application of the document transmission system.

Those skilled in the art will readily observe that numerous modifications and alterations of the device and method may be made while retaining the teachings of the invention.

What is claimed is:

1. A document transmission system, comprising:
a document provider, for receiving a paper with data to provide a document;
a document receiver, for receiving the document; and
a network transmission system, coupled to the document provider and the document receiver, for respectively providing network addresses to the document provider and the document receiver, and for transmitting the document from the document provider to the document receiver according to the network addresses.

2. The document transmission system of claim 1, further comprising a server, coupled to the network transmission system, for buffering the document when the document provider sends the document but the document receiver cannot receive the document.

3. The document transmission system of claim 1, wherein the document provider is one of a facsimile, a scanner and a multifunction printer.

4. The document transmission system of claim 1, wherein the document receiver automatically prints out the document when the document receiver receives the document.

5. The document transmission system of claim 4, wherein the document receiver is one of a facsimile, a printer and a multifunction printer.

6. The document transmission system of claim 1, wherein the network transmission system is Internet or Intranet.

7. The document transmission system of claim 1, wherein the document provider and the document receiver both include a document transmission protocol program.

8. The document transmission system of claim 1, wherein the network transmission system includes a document transmission protocol program.

9. A document transmission method, comprising:
utilizing a document provider to receive a paper with data to provide a document;
providing a document;
utilizing a document receiver to receive the document; and
utilizing a network transmission system for respectively providing network addresses to the document provider and the document receiver, and for transmitting the document from the document provider to the document receiver according to the network addresses.

10. The document transmission method of claim 9, further comprising:
providing a server, coupled to the network transmission system, for buffering the document when the document provider sends the document but the document receiver cannot receive the document.

11. The document transmission method of claim 9, wherein the document provider is one of a facsimile, a scanner and a multifunction printer.

12. The document transmission method of claim 9, wherein the document receiver automatically prints out the document when the document receiver receives the document.

13. The document transmission method of claim 12, wherein the document receiver is one of a facsimile, a printer and a multifunction printer.

14. The document transmission method of claim 9, wherein the network transmission system is Internet or Intranet.

15. The document transmission method of claim 9, wherein the document provider and the document receiver both include a document transmission protocol program.

16. The document transmission method of claim 9, wherein the network transmission system includes a document transmission protocol program.
